(19) United States
(12) Patent Application Publication
(10) Pub. No.: US 2005/0107543 A1
(43) Pub. Date: May 19, 2005

(54) Fluoro linkers and their use as linkers for enzyme-activated drug conjugates

(75) Inventors: Francesco Angelucci, Milan (IT); Antonino Suarato, Milan (IT); Michele Caruso, Milan (IT); Alessandra Scolaro, Milan (IT); Enrico Pesenti, Milan (IT); Daniela Faiardi, Pavia (IT)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Pfizer inc.

(21) Appl. No.: 10/486,477

(22) PCT Filed: Jul. 29, 2002
(86) PCT No.: PCT/EP02/08637

(30) Foreign Application Priority Data
Aug. 10, 2001 (GB) 0119578.3

(51) Int. Cl. C07F 7/02; C08G 63/48; C08G 63/91

(52) U.S. Cl. 525/259; 546/14; 536/53; 525/54.1

(57) ABSTRACT

The present invention provides compounds or formula (1) R₁—HN—CH₂—CF₂—(CH₂)ₗ—CR₃R₄—CO—R₂, wherein: l is 0, 1 or 2, R₁ is a labile amino protecting group, R₂ is hydroxy group or the residue or an activated ester or halogen atom; R₃ and R₄ are independently hydrogen atom or C₁-C₄ alkyl chain. There are also provided their preparation and the water-soluble conjugates based on these linkers, endowed with selective anticancer activity.

The present invention relates to amino-difluoro-alkanoic acid derivatives, their preparation and their use as linkers for enzyme-activated drug conjugates. In particular the present invention provides a compound of formula (1)
R₁—HN—CH₂—CF₂—(CH₂)ₗ—CR₃R₄—CO—R₂ (1)
wherein:
l is 0, 1 or 2;
R₁ is a labile amino protecting group; R₂ is hydroxy, the residue of an activated ester or a halogen atom; and
R₃ and R₄, which are the same or different, are independently hydrogen or C₁-C₄ alkyl.

Preferably, l is 1, R₃ and R₄ are hydrogen atoms, the labile amino protecting group is selected from tert-butoxycarbonyl (BOC), 9-fluorenyl methoxycarbonyl (FMOC), triphenylsilyl, diphenylmethylene and triphenylmethyl, and the activated ester residue is selected from p-nitrophenol, N-hydroxysuccinimido and halogen atom such as chlorine.

Further object of the present invention are compounds of formula (2):
W—[—HN—Y—CO—]ₚ—S₀—HN—CH₂—CF₂—(CH₂)ₗ—CR₃R₄—CO-D (2)
wherein:
D is the residue of a drug bearing secondary or tertiary hydroxyl groups linked through an ester bond;
R₃ and R₄, which are the same or different, are independently hydrogen or C₁-C₄ alkyl;
S₀ is a peptide capable of being selectively cleaved at a tumor site by enzymes there expressed in the active form;
Y is C₂-C₁₂ linear or branched alkylene chain, which is unsubstituted or substituted by hydroxyl;
p is 0 or 1; and
W is a water-soluble polymer or a water-soluble low molecular weight compound.

The present invention also provides a process for preparing the compounds of formula (2) and their use for the treatment of mammalian malignancies, mainly solid tumors.

Linear or branched non α-aminoacid residues directly linked to drug are crucial to confer plasma stability to the ester linkage while introduction of fluorine atoms at position β to the amino group in compounds of formula (2) allows drug release after proteolysis of the enzymatic substrate S₀. In fact we have found that linear or branched non α-aminoacid of C₄-C₅ carbon skeleton such as 4-aminobutyrric acid, 5-aminopentanoic acid, 4-amino-3,3′-dimethylbutyrric acid or 6-aminohexanoic acid, confer plasma stability to the ester bond of the corresponding drug conjugates of formula H₂N—X-D, wherein X is the acyl residue of the above mentioned non α-aminoacids and D is as previously defined, but do not permit drug release due to the high pKa (>7.5) of the amino group. In these conditions, internal chemical rearrangement leading to the formation of a 5- or 6-membered lactame and to the release of the active drug cannot occur. On the other hand the presence of fluorine atoms at position β to the amino group decreases the pKa value of the amino group and allows drug release also at pH lower than 7.

Therefore compounds of formula H₂N—CH₂—CF₂—(CH₂)ₗ—CR₃R₄—CO-D, wherein l, R₃ and R₄ are as above defined, generated after the proteolytic cleavage of the substrate S₀ in the drug-conjugate of formula (2), lead to the formation of 4 to 7 membered lactame of formula (3) and to the release of the active drug D at the site of action. 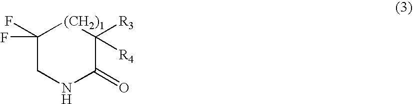
wherein l, R₃ and R₄ are as above defined.

Thus the present invention provides compounds of formula (1) and (2). The latter are stabilized in plasma by the presence of the linker L which, after proteolytic digestion by enzymes, such as matrix metalloproteinases (mainly gelatinases), of the specific substrate S₀, rearranges to compound (3) and allows the release of the active drug D, particularly at tumor site.

The selective release of a drug, in particular an anticancer drug such as a cyotoxic, at the site of malignancy is expected to overcome unwanted peripheral toxicities and low therapeutic efficacy of anticancer drugs. Enzymes overexpressed in their active form at tumor site can mediate the selective release of a drug linked to an enzyme substrate S₀. It is well known that several proteinases are implicated in the process of tumor invasion and metastasis by degrading basement membrane components (Cancer Bulletin, 39: 142, 1987). An important class of these enzymes are the matrixmetalloprotinases, such as the type IV collagenases/gelatinases (Biochim. Biophys. Acta, 907: 191, 1987). A correlation between tumor secretion of matrix metalloproteinases, particularly MMP2 or gelatinase A, and experimental metastasis has been reported (J. Natl. Cancer Inst., 81: 556, 1987; Cancer Res., 47: 4869, 1987).

Therefore, an enzyme-activated antitumor drug conjugates of formula (2) is expected to release the active agent at tumor site through a multiple mechanism which implies: cleavage of the substrate S₀ by the enzyme, such as matrix metalloproteinases; proteolytic digestion of the remaining amino acids to form intermediates of formula H₂N—CH₂—CF₂—(CH₂)ₗ—CR₃R₄—CO-D as above defined; and their internal chemical rearrangement to compound (3).

Another aspect of the present invention is to provide a method of treating solid tumors, which comprises administration of the novel drug-conjugates of general formula (2).

The solubilizer W is a water-soluble polymer or low molecular weight compound.

For example, water-soluble low molecular weight such as polypyrrolecarboxamidonaphthalene derivatives are described in WO9626950.

Preferably W represents a water-soluble polymer such as poly-glutamic acid, carboxylated dextranes, carboxylated polyethylenglycols or a polymer based on hydroxypropylmethacryloylamide. Most preferably W is a polymer based on N-(2-hydroxypropyl) methacryloylamide (HPMA).

Most preferably Y represents —(CH₂)₅— and p is 1.

Although S₀ represents any peptide designed to be selectively cleaved at the tumor site by enzymes there expressed in the active form, without limiting the meaning of S₀, in the following examples are reported peptide sequences that are selectively cleaved by gelatinase. For example S₀ may represent a sequence having from four to five natural or synthetic amino acids. More preferably, S₀ represents one of the sequences already described in our previous PCT patent application EP/01/07883 of Jul. 9, 2001: Met(O)-Gly-Cys(Bn)-Leu, Met(O)-Gly-Cys(Bn)-Gly, Met(O)-Gly-Cys(Bn)-Gly-Leu, Met(O)-Gly-Cys(Bn)-Trp-Gly, Met(O)-Gly-Cys(Bn)-pFF-Gly, Met(O)-Gly-Cys(Bn)-Gly-Gly, Met(O)-Gly-Cys(Bn)-Leu-Gly, Smc-Gly-Cys(Bn)-Leu, Smc-Gly-Cys(Bn)-Trp, Smc-Gly-Cys(Bn)-pFF, Smc-Gly-Cys(Bn)-Gly, Smc-Gly-Cys(Bn)-Trp-Gly, Smc-Gly-Cys(Bn)-pFF-Gly, Smc-Gly-Cys(Bn)-Gly-Gly, Smc-Gly-Cys(Bn)-Leu-Gly, Smc-Gly-Leu-Trp, Smc-Gly-Tha-Trp, Smc-Gly-Met-Trp, Smc-Gly-Tha-Trp-Gly, Smc-Gly-Met-Trp-Gly, Leu-Gly-Cys(Bn)-Leu, Leu-Gly-Cys(Bn)-Gly, Leu-Gly-Cys(Bn)-Leu-Gly, Leu-Gly-Cys(Bn)-Gly-Gly, Leu-Gly-Leu-Leu, Leu-Gly-Leu-Trp, Leu-Gly-Leu-Leu-Gly or Leu-Gly-Leu-Trp-Gly.

The most preferred peptide sequences S₀ are:
Met(O)-Gly-Cys(Bn)-Leu, Met(O)-Gly-Cys(Bn)-Gly, Met(O)-Gly-Cys(Bn)-Gly-Gly, Met(O)-Gly-Cys(Bn)-Leu-Gly, Smc-Gly-Cys(Bn)-Leu, Smc-Gly-Cys(Bn)-Gly, Smc-Gly-Cys(Bn)-Gly-Gly, Smc-Gly-Cys(Bn)-Leu-Gly, Leu-Gly-Cys(Bn)-Leu, Leu-Gly-Cys(Bn)-Gly, Leu-Gly-Cys(Bn)-Leu-Gly, Leu-Gly-Cys(Bn)-Gly-Gly, Leu-Gly-Leu-Leu or Leu-Gly-Leu-Leu-Gly, in which Met(O) is methionine sulfoxide, Cys(Bn) is S-benzyl-cysteine, Smc is S-methylcysteine, Tha is thienyl alanine, pFF is p-fluorophenylglycine.

Preferably D is the residue of an antitumor agent bearing secondary or tertiary hydroxyl groups by which the drug is linked to the linker through an ester bond. Preferred antitumor agents bearing secondary or tertiary hydroxyl groups include agents belonging to the class of camptothecins, anthracyclines, taxanes, vinca alkaloids, cytotoxic nucleosides, podophyllotoxins. Representatives of those classes include: camptothecin, 7-ethyl-10-hydroxycamptothecin, 9-aminocamptothecin, doxorubicin, daunorubicin, 4′-epidoxorubicin, 4-demethoxydaunorubicin, 3′-(2-methoxymorpholino)doxorubicin, 4-deacetylvinblastine, 4-deacetyl-vincristine, vindesine, paclitaxel, docetaxel., etoposide. Other antitumor drugs of the present invention include tumor cell cycle inhibitors or inhibitors of enzymes involved in the tumor growth and spread. Most preferably D represents the residue of 7-ethyl-10-hydroxycamptothecin (4):

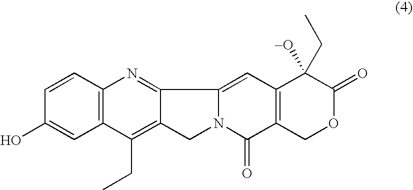

The present invention also provides methods for preparing the compounds of formula (1), which process comprises reacting a compound of the formula II
R′₁—HN—CH₂—CH₂—(CH₂)ₗ—CR₃R₄—COOR′₂ II
wherein R₃ and R₄ are as above defined, R′₁ is an N-protecting group and R′₂ is C₁-C₄ alkyl, phenyl or phenyl-C₁-C₄ alkyl, with a fluorinating agent such as DAST, then
removing the N-protecting group and the ester residue from the resultant compound of formula III
R′₁—HN—CH₂—CF₂—(CH₂)ₗ—CR₃R₄—COOR′₂ III
wherein R′₁, R′₂, R₃, R₄ and l are as above defined;
and then introducing the labile N-protecting group R₁ as previously defined, and optionally the activating ester residue R₂ as above defined into the resultant amino acid derivative of the formula IV
H₂N—CH₂—CF₂—(CH₂)ₗ—CR₃R₄—COOH IV
wherein R₃, R₄ and l are as above defined, to give a desired compound of the formula (1). The N-protecting group R₁ is typically a fairly stable group such as the phthaloyl protecting group C₆H₄(CO)₂.

For example compound of formula (1′d), in which R₁ is an amino-protecting group such as tert-butoxy and R₂ is the residue of an activated ester such as p-nitrophenol, and R₃ and R₄ are both hydrogen atoms and l is 1, is prepared by reacting the ethyl ester of the amino-protected 5-amino-4-oxo-pentanoic acid of formula (7′), protected with a bi-functional group such as phthaloyl, with a fluorinated agent such as DAST. Then removing the amino protecting group from the resultant di-fluoro derivative (1′a) and also the ester group to obtain 5-amino-4,4′-difluoro pentanoic acid (1′b), which is protected at the amino group with the acid labile tert-butoxycarbonyl group, compound (1′c), and activated at the carboxyl as p-nitrophenyl ester, compound (1′d). Compound of formula (7′: R₃=R₄=H) can be prepared starting from 5-aminolevulinic acid (5′) which is first converted to N-phthaloyl derivative, compound (6′), then into the ethyl ester (7′) following known synthetic procedures. A more general method for preparing compounds of formula (7) in which R₃ and R₄ also represent alkyl chains or hydrogen atoms can be condensing N-phthaloyl-glycine (8) with Meldrum's acid as described by Baoquing Li et al., in Bioorg. Med. Chem. Lett, 9:2629 (1999) then treating the resultant adduct (9) with benzyl alcohol to form β-ketoester (10) which is alkylated with a suitable α-halo ester derivative of general formula R₅—CR₃R₄—COOR₆ in which R₅ is an halogen atom, preferably bromine, R₃ and R₄ are as above defined and R₅ is the alkyl residue, preferably methyl or ethyl, in presence of sodium hydride and then hydrogenated to remove the benzyl ester group and decarboxylated to form (7). For example, α-halo ester derivative of general formula R₅—CR₃R₄—COOR₆ are commercially available α-bromo ethyl or methyl ester derivatives (R₅=Br and R₆=C₂H₅ or CH₃) of:
propanoic acid, 2-bromo-, ethyl ester (R₃=H, R₄=CH₃, R₆=C₂H₅),
propanoic acid, 2-bromo-2-methyl-, methyl ester (R₃=R₄=R₆=CH₃),
butanoic acid, 2-bromo-2-methyl-, ethyl ester (R₃=CH₃, R₄═R₆=C₂H₅),
butanoic acid, 2-bromo-, methyl ester, (R₃=H, R₄=C₂H₅, R₆=CH₃),
pentanoic acid, 2-bromo-, ethyl ester (R₃=H, R₄=nC₃H₇, R₆=C₂H₅),
butanoic acid, 2-bromo-3-methyl-, ethyl ester (R₃=H, R₄=iC₃H₇, R₆=C₂H₅),
propanoic acid, 2-bromo-2-methyl-, ethyl ester (R₃=R₄=CH₃, R₆=C₂H₅),
butanoic acid, 2-bromo-2-methyl-, methyl ester (R₃=CH₃, R₄=C₂H₅, R₆=CH₃),
butanoic acid, 2-bromo-2-methyl-, methyl ester, (R₃=CH₃, R₄=C₂H₅, R₆=CH₃,
pentanoic acid, 2-bromo-2-methyl-ethyl ester (R₃=CH₃, R₄=nC₃H₇, R₆=C₂H₅),
butanoic acid, 2-bromo-2-ethyl-ethyl ester (R₃=R₄=R₆=C₂ H₅),
pentanoic acid, 2-bromo-, methyl ester (R₃=H, R₄=nC₃H₇, R₆=CH₃),
hexanoic acid, 2-bromo-, ethyl ester (R₃=H, R₄=nC₄H₉, R₆=C₂H₅),
butanoic acid, 2-bromo-2,3-dimethyl-, ethyl ester (R₃=CH₃, R₄=iC₃H₉, R₆=C₂H₅),
pentanoic acid, 2-bromo-4-methyl-, ethyl ester (R₃=H, R₄=iC₄H₉, R₆=C₂H₅),
pentanoic acid, 2-bromo-3-methyl-, ethyl ester (R₃=H, R₄=CH₃CHC₂H₅, R₆=C₂H₅),

It is worth noting the importance of protecting both amino hydrogen atoms, such as with the pthaloyl moiety, in compound (7). In fact we have found that mono-functional amino-protecting groups do not permit the formation of 4,4′-difluoro derivative in presence of DAST, but produce a mixture of undefined compounds. The phthaloyl amino-protecting group present in compound (7) is fairly stable in the reaction conditions and allows the formation of the desired compound.

For example, 5-aminolevulinic acid (5′) is reacted with N-ethoxycarbonylphthalimide, in basic aqueous medium, for example in presence of sodium carbonate, to give the amino-protected phthaloyl derivative (6′) which is easily converted to ethyl ester (7′) at reflux with ethanol/toluene and a catalyst such as p-toluensulfonic acid in a Dean-Stark apparatus. Fluorination of ketone at position C-4 is performed as described in J. Am. Chem. Soc. 107, 735 (1985) in aprotic solvent, such as methylene dichloride with diethylaminosulfur trifluoride (DAST), from four to seven equivalents, at temperature from −10 to 10° C., preferably at 4° C. and for one to seven days. The resultant 4,4′-difluoro derivative (1′a) is then hydrolyzed in acidic strong conditions, for example with mineral acid such as 6N hydrochloric acid at reflux to remove the amino-protecting group. In such conditions also the ethyl ester group is hydrolyzed and 5-amino-4,4′-difluoro-pentanoic acid (1′b) is recovered as hydrochloric salt and rapidly converted into the acid labile N-BOC-derivative (1′c) by treatment with di-tert-butyl dicarbonate in presence of organic base, such as triethylamine, at temperature from 0 to 5° C., preferably 4° C. The activated ester derivative, for example the p-nitrophenyl ester, compound (1′d) used for the coupling reaction with the hydroxyl group of the drug, is formed upon reaction with p-nitrophenol in presence of condensing agent such as dicyclohexylcarbodiimide.

In another example phthaloyl glycine (8) is reacted with 10% molar excess of Meldrum's acid in polar organic solvents, such as dimethylformamide, in presence of a condensing agent, such as 1,1′-carbonyldiimidazole, at temperature from 0 to 40° C., from 24 to 72 hour, preferably for 24 hours, to produce intermediate (9). Preferably the reaction is carried on at room temperature for 24 hours. Compound (9) is then reacted with benzyl alcohol at reflux for 18 hours to give benzyl N-phthaloyl-4-amino-3-oxo-butyrrate (10) which is alkylated with a suitable α-halo ester derivative of general formula R₅—CR₃R₄—COOR₆ in the same conditions as previously described.

These reactions are illustrated in Scheme I.

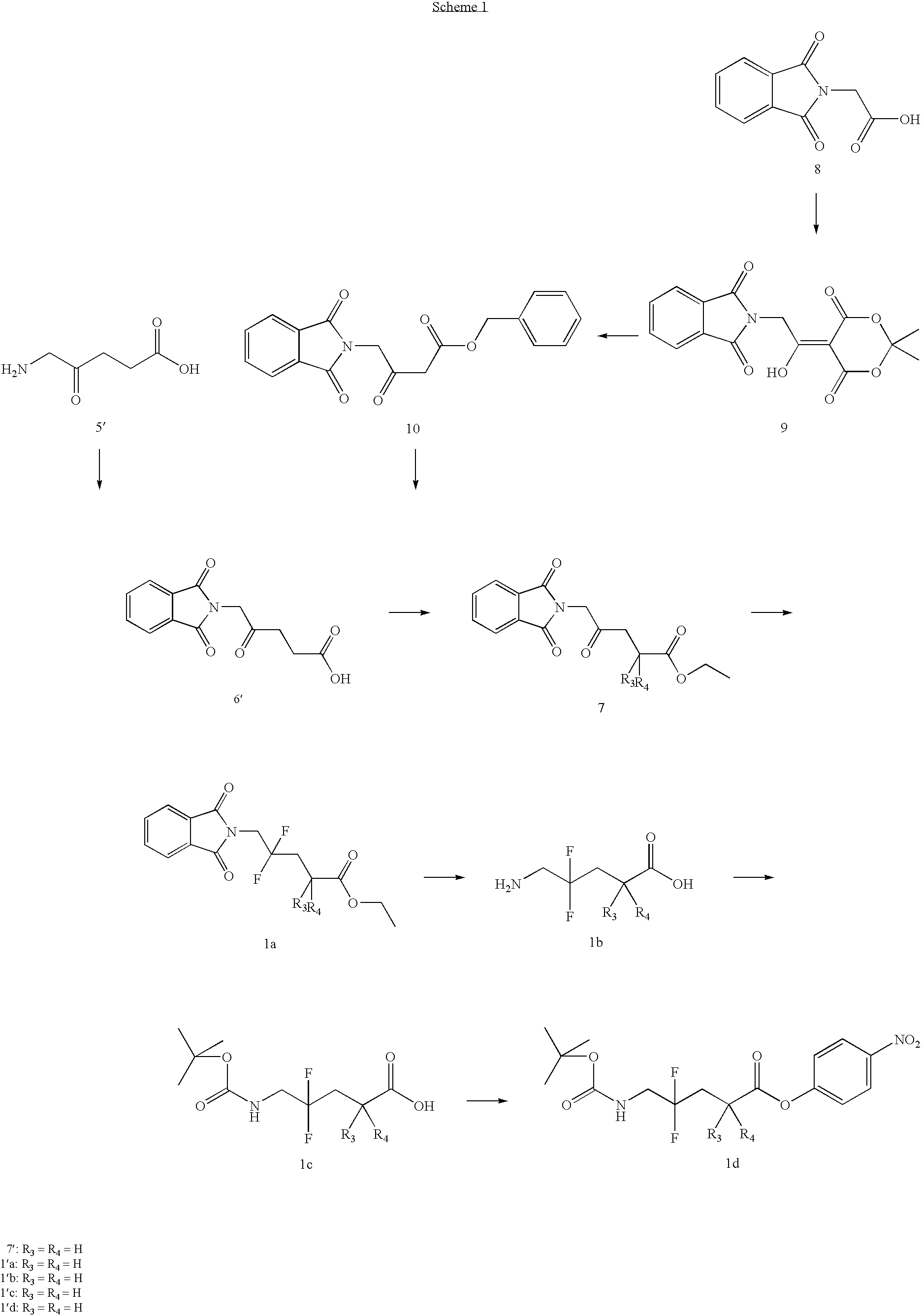

The present invention also provides methods for preparing a compound of formula (2), which process comprises reacting compound of formula (18)
H—[—HN—Y—CO—]ₚ—S₀—HN—CH₂—CF₂—(CH₂)ₗ—CR₃R₄—CO-D (18)
wherein Y, p, S₀, l, R₃, R₄ and D are as above defined, with a polymer or water soluble molecule W bearing suitable functional groups for the coupling with compounds (18). Suitable functional groups on W for the attachment to compounds (18) comprise carboxyl groups or activated carboxyl groups such as p-nitrophenyl ester or imidazoyl ester. Compounds of formula (18) and the corresponding salt derivatives (18′) are also provided by the present invention. Also provided is a process for preparing a compound of formula (18) by removing under acidic conditions the N-protecting group from a derivative of formula (16):
R₁—[—HN—Y—CO—]ₚ—S₀—HN—CH₂—CF₂—(CH₂)ₗ—CR₃R₄—CO-D (16)
wherein R₁, Y, p, S₁, S₀, l, R₃, R₄ and D are as above defined and
optionally converting a resultant compound of general formula (18′) into the corresponding free amino derivative (18) by mild basic treatment.

The compound of formula (16) can be conveniently be prepared starting from the new compounds of formula (1) of the present invention and following different synthetic methods.

One method comprises:
(a) reacting a compound of formula (1) as previously defined in which R₁ is amino-protecting group, preferably the tert-butoxycarbonyl, and R₂ is preferably a leaving group, more preferably p-nitrophenol, with the hydroxyl group of a drug D to form compound of formula (11)
   R₁—HN—CH₂—CF₂—(CH₂)ₗ—CR₃R₄—CO-D (11)
   wherein R₁, l, R₃, R₄ and D are as defined above, optionally in the presence of a condensing agent;
(b) removing the amino protecting group R₁ from the resultant compound to give a compound of formula (12)
   H₂N—CH₂—CF₂—(CH₂)ₗ—CR₃R₄—CO-D (12)
   wherein l, R₃, R₄ and D are as above defined; and
(c) reacting the resultant compound with a derivatives of formula (13) or (14)
   R₁—S₁—R₂ (13)
   R₁—[—HN—Y—CO—]ₚ—S₀—R₂ (14)
   wherein Y, p, S₀, R₁ and R₂ are as above defined and S₁ represents the first amino acid of the sequence S₀, to give derivatives of formula (15) and (16) respectively, the latter as previously defined:
      R₁—S₁—HN—CH₂—CF₂—(CH₂)ₗ—CR₃R₄—CO-D (15)
   wherein R₁, Y, p, S₁, l, R₃, R₄ and D are as above defined;
   then
(d) removing the amino protecting group from compounds of formula (15) to obtain derivatives (17):
   H—S₁—HN—CH₂—CF₂—(CH₂)ₗ—CR₃R₄—CO-D (17)
   wherein R₁, S₁, l, R₃, R₄ and D are as above defined and then,
(e) reacting said compound of formula (17) with a compound of formula (19)
   R₁—[—HN—Y—CO—]ₚ—S₀₋₁—R₂ (19)
   wherein R₁, R₂, Y p are as previously defined and S₀₋₁ represents a peptide that, when linked together to S₁, forms a peptide residue S₀ as above defined to give the same derivative (16) above defined; or
(f) alternatively, compound (17) can be reacted with a derivative of formula (20)
   R₁—S₂—R₂ (20)
   wherein R₁ and R₂ are as above defined and S₂ represents the second amino acid of the residue S₀ to form a compound of formula (21)
      R₁—S₂—S₁—HN—CH₂—CF₂—(CH₂)ₗ—CR₃R₄—CO-D (21)
   wherein R₁, S₁, S₂, R₃, R₄ and D are as above defined and the resultant compound is
      hydrolyzed to give the free amino form (22)
      H—S₂—S₁—HN—CH₂—CF₂—(CH₂)ₗ—CR₃R₄—Co-D (22)
   wherein S₁, S₂, l, R₃, R₄ and D are as above defined and the resultant compound is reacted with a compound of formula (23)
      R₁—[—HN—Y—CO—]ₚ—S₀₋₂—R₂ (23)
   wherein R₁, R₂, Y, p are as above defined and S₀₋₂ represents the residue of the peptide sequence S₀ that, when linked together to S₂—S₁ form a peptide residue S₀ as above defined to give the same derivative of formula (16) as above defined.

More generally method for the preparation of compounds of formula (16) comprises reacting a compound of formula (24) with a compound of the formula (25)
H—Sₓ—HN—CH₂—CF₂—(CH₂)₁—CR₃R₄—CO-D-R₂ (24)
R₁—[—HN—Y—CO—]ₚ—S_{y} (25)
wherein l, Y, D, p, R₁, R₂, R₃ and R₄ are as above defined, and Sₓ, S_{y} are independently an amino acid or peptide residue characterized that, when linked together, form a peptide residue S₀ as above defined, optionally in presence of a condensing agent. Formula (24) and (25) may have the same meaning of formula (17) and (19) when Sₓ and S_{y} represent S₁ and S₀₋₁ respectively. In another case, formula (24) and (25) may represent compounds (22) and (23) when Sₓ and S_{y} are the dipeptide S₁-S₂ and the residue S₀₋₂ respectively.

Preferably S₁ represents: Gly, Leu, Trp, pFF and S₂ represents: Cys(Bn), Gly, Trp, pFF, Tha, Met.

Preferably S₀₋₁ represents: Met(O)-Gly-Cys(Bn), Met(O)-Gly-Cys(Bn)-Gly, Smc-Gly-Cys(Bn), Smc-Gly-Cys(Bn)-Gly, Smc-Gly-Cys(Bn)-Leu, Leu-Gly-Cys(Bn)SE, Leu-Gly-Cys(Bn)-Leu, Leu-Gly-Leu, Leu-Gly-Leu-Leu: and S₀₋₂ represents: Met(O)-Gly, Met(O)-Gly-Cys(Bn), Smc-Gly, Smc-Gly-Cys(Bn), Leu-Gly, Leu-Gly-Cys(Bn), Leu-Gly-Leu.

Preferably S_{y} represents Met(O)-Gly, Smc-Gly or Leu-Gly, and Sₓ represents Cys(Bn)-Leu, Cys(Bn)-Gly, Cys(Bn)-Gly-Leu, Cys(Bn)-Trp-Gly, -Cys(Bn)-pFF-Gly, Cys(Bn)-Gly-Gly, Cys(Bn)-Leu-Gly, Cys(Bn)-Trp, Cys(Bn)-pFF, Leu-Trp, Tha-Trp, Met-Trp, Tha-Trp-Gly, Met-Trp-Gly, Leu-Leu, Leu-Leu-Gly or Leu-Trp-Gly.

More preferably, S₁ is Leu and S₀₋₂ is Met(O)-Gly-Cys(Bn).

The present invention also provides the compounds of the formula (17), (18), (22) and (24) and their water soluble acid salt that can be indicated as (17′), (18′), (22′) and (24′) respectively.

Any suitable acid may be used to form the salt derivatives; preferably these acid salt derivatives are in the form of hydrochloride or trifluoroacetate. The salt of formula (18′), for instance, has the same structure as the corresponding free base but is associated with a suitable acid moiety.

The preparation of compounds of formula (13), (14), (19), (20), (23) and (25) follows procedures known for the preparation of peptides. For example by using solid phase synthesis through a stepwise addition of amino protected amino acids to a growing chain attached to a solid resin, such as Wang resin. Preferably the N-protecting group is Fmoc. Thus the C-terminus of N-protected amino acid is linked to the resin in aprotic organic solvents such as methylene chloride in presence of organic base such as diisopropylethylamine (DIPEA). The completion of chain elongation is accomplished by the standard repetition of the deprotection/coupling cycle. Preferably the Fmoc protecting groups are removed with piperidine 20% in N-methyl-2-pyrrolidone and coupling steps are performed with TBTU, HOBt, DIPEA in N-methyl-2-pyrrolidone. Resin cleavage may be accomplished with a mixture of methylene chloride, acetic acid, trifluoroacetic acid (3/1/1 v/v) or methylene chloride, trifluoroacetic (99/1 v/v).

The preparation of compounds of formula (18) follows synthetic procedures similar to those described in our previous PCT Publication No. WO99/17805 and WO99/17804 and in the U.S. Pat. No. 5,773,552 and U.S. Pat. No. 5,618,790.

The preparation of compounds of formula (18), intermediates for the preparation of drug-conjugates (2), is illustrated in the following synthetic Scheme. For example in Scheme 2 is illustrated the preparation of 7-ethyl-10-hydroxy-20-O-[6-aminohexanoyl-(methionyl-sulfox ide)-glycyl-(S-benzyl-cysteinyl)-leucyl-(5-amino-4,4′-difluoro-pentanoyl)]-camptothecin (18a). The synthetic process comprises sequential attachments of N-protected amino acids to 7-ethyl-10-hydroxy-camptothecin (4). In particular (4) is reacted with a molar excess, for example up to 2.5 mol. equivalents, of 4-nitrophenyl, t-butoxycarbonyl-5-amino-4,4′-difluoro-pentanoate (1′d) in anhydrous non-protic solvent such as dimethylsulfoxide, in presence of an activating agent such as 4-dimethylamino pyridine (DMAP), under argon. In this manner, the protected amino acid is introduced at both hydroxylated positions C-10 and C-20 of compound (4). The reaction can typically be effected for from 8 to 48 hours. The reaction is typically carried out at temperature from 15 to 40° C. The substituent group at position C-10 is removed in presence of a secondary amine, such as morpholine or 1-amino-prolinol, to give the mono-substituted N-Boc-derivative at C-20 (11a). The amino protecting group may be removed by acidic treatment, such as 1N HCl in acetic acid for from 10′ to 6 hours at a temperature of from 100 to 30° C.; preferably for half an hour at room temperature to give the 7-ethyl-10-hydroxy-20-O-(5-amino-4,4′-difluoro-pentanoyl)-camptothecin derivative (12′a) in the salt form. The second amino acid leucine may be introduced by reacting compound (12′a) with molar excess, for example up to two mol. equivalents of N-t-butoxycarbonyl-leucine in anhydrous non-protic solvent, preferably dimethylformamide, in presence of condensing agents such as 1-hydroxybenzotriazole (HOBt), O-(benzotriazol-1-yl)-N,N,N′,N′-tetramethyluronium tetra-fluoborate (TBTU) and diisopropylamine (DIPEA). The reaction can typically be effected for from 8 to 48 hours. The reaction is typically carried out at a temperature from 15 to 40° C. Treatment with morpholine, followed by acidic displacement of the N-protecting group of compound (21a) affords 7-ethyl-10-hydroxy-20-O-[leucyl-(5-amino-4,4′-difluoro-pentanoyl)-camptothecin in acidic salt form (22′a). This compound is treated in sequence with N-t-butoxycarbonyl-(6-aminohexanoyl-methionyl sulfoxide-glycyl-(S-benzyl-cysteine) in the same conditions previously described for the attachment of leucine to produce, after removal of the amino-protecting group, the final intermediate (18′a) in the form of salt, such as trifluoroacetate salt derivative.

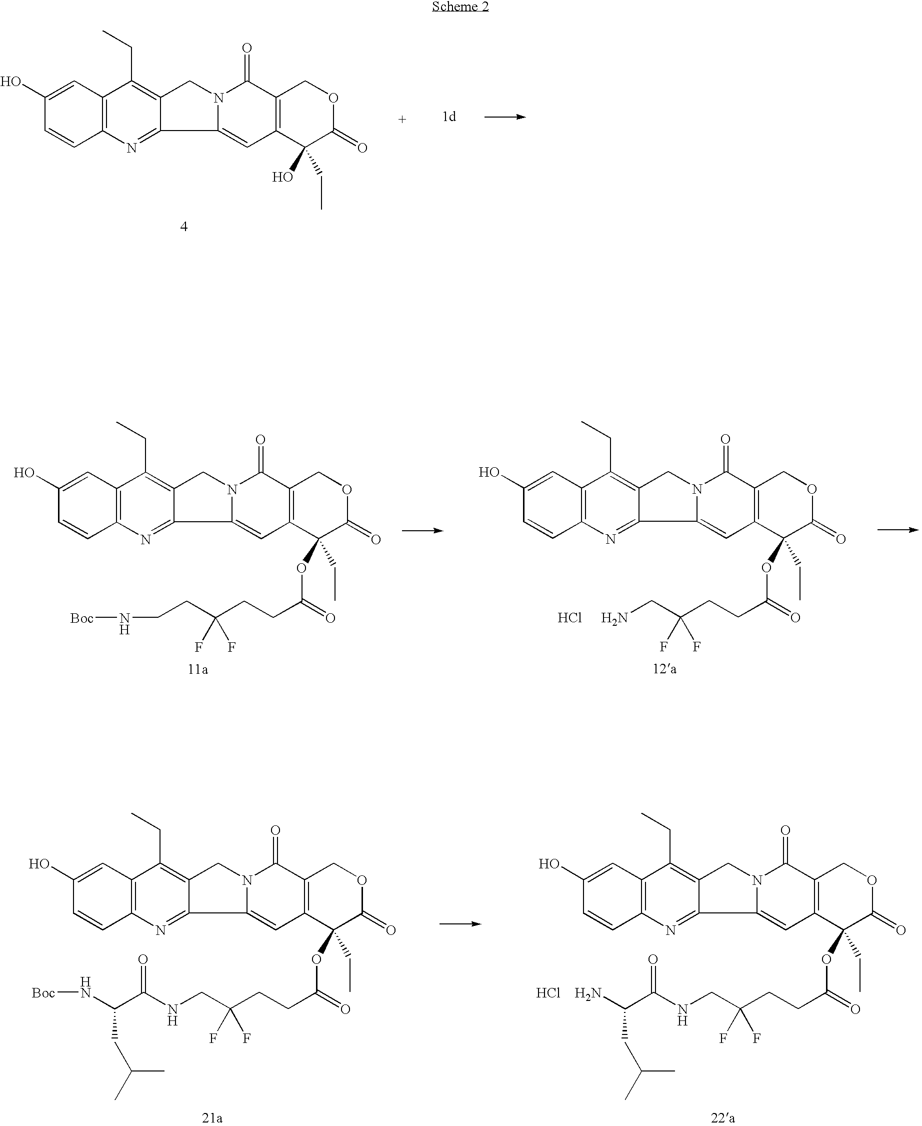

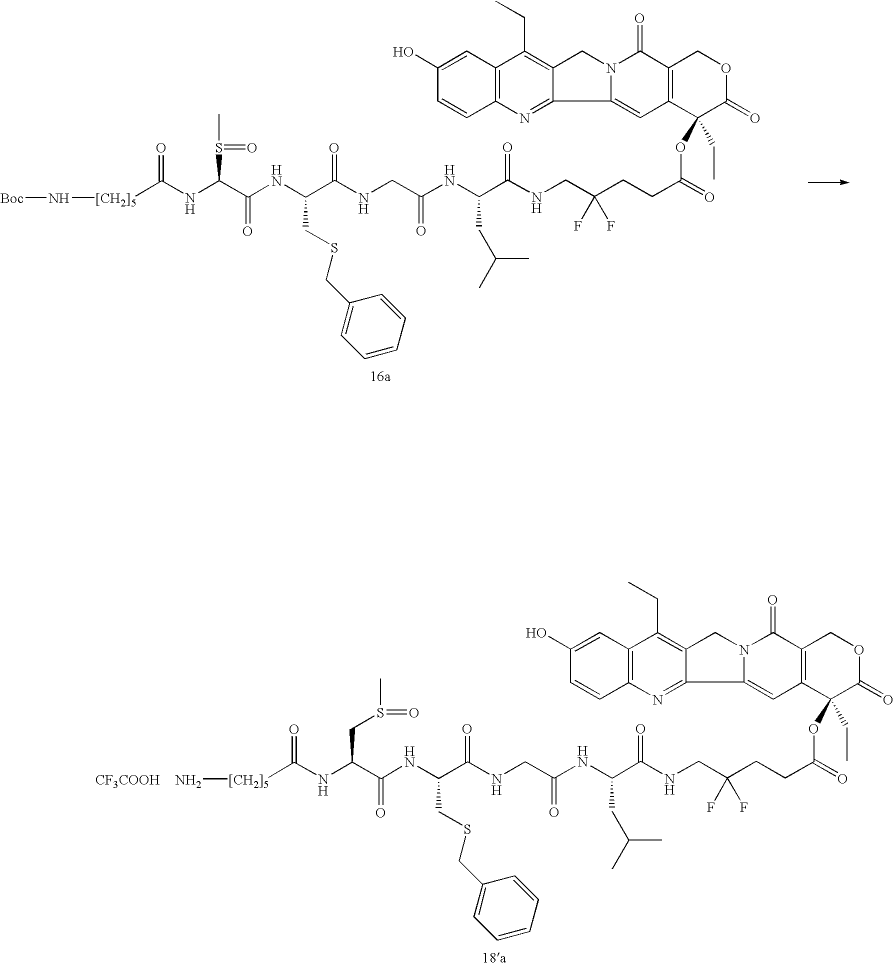

As previously illustrated the present invention also provides compounds of formula (2), preferably water soluble polymer of enzyme-activated drug conjugates, which are prepared by condensing compounds of formula (18) with a compound W bearing suitable functional groups for the coupling with compound (18). Suitable functional groups on compound W, preferably a polymer, for the attachment to compounds (18) comprise carboxyl groups or activated carboxyl groups such as p-nitrophenyl ester or imidazolyl ester.

Without limiting the scope of the present invention hereinafter are reported examples of polymeric drug-conjugates of formula (2) in which the water soluble polymer W is based on N-(2-hydroxy propyl)methacryloylamide (HPMA). In such case the polymeric enzyme-activated drug conjugates (2) comprise a soluble polymer W consisting of:
(i) from 85 to 97 mol % of N-(2-hydroxypropyl)methacryloylamide units represented by formula (26) 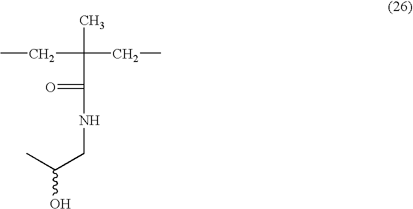
(ii) from 3 to 15 mol % of units represented by formula (27) 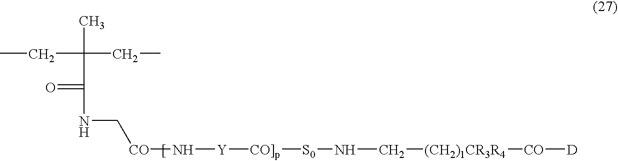
   in which Y, p, 1, S₀, R₃, R₄ and D and are as above defined,
(iii) from 0 to 12 mol % of N-methacryloyl-glycine or N-(2-hydroxypropyl) methacryloyl-glycinamide units represented by formula (28) 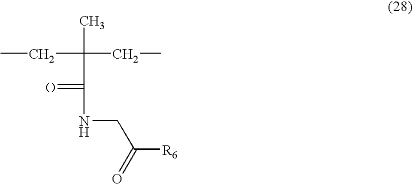
   wherein R₆ represents a hydroxy group or a residue of formula —NH—CH₂—CH(OH)—CH₃.

This polymeric drug-conjugate (2) may also be represented as follows:
[(26)]ₓ; [(27)]_{y}; [(28)]_{z} wherein (26), (27) and (28) are units of the formula as above defined, and x is from 85 to 97 mol %, y is from 3 to 15 mol % and z is from 0 to 12 mol %.

Preferably, this polymeric enzyme-activated drug conjugate (2) as above defined contains the N-(2-hydroxypropyl) methacryloyl amide units represented by the formula (26) in a proportion of 90% or more; more preferably 90%. The conjugate may also contain from 3 to 10 mol % of methacryloyl-glycyl-derivative units represented by the formula (27), more preferably 10 mol % of such units.

Preferably (2) does not contain residues of formula (28), i.e. z is 0.

In such case, the process for preparing water soluble polymer of enzyme-activated drug conjugates of formula (2) comprises reacting compounds of general formula (18) with an activated polymer W′ consisting essentially of:
(i) from 85 to 97 mol % of N-(2-hydroxypropyl)methacryloylamide units represented by formula (26) as above defined, and
(ii) from 3 to 15 mol % of N-methacryloyl-glycyl units represented by formula (29) 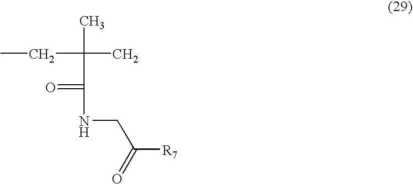
   wherein R₇ is the residue of an active ester, and optionally displacing the remaining active ester groups with 1-amino-2-propanol.

Polymers of formula W1 have been already described in Makromol. Chem. 178: 2159 1977. Preferably, the reaction between a polymer (W1) in which R₄ in formula (29) represents the residue of active ester and a compound of formula (18) to prepare water soluble polymer of enzyme-activated drug conjugates of formula (2) is carried out in an anhydrous polar organic solvent such as dimethyl sulfoxide. The reaction can typically be carried out at temperature from 15 to 30° C., preferably at room temperature for 15 hours; then the aminolysis of the remaining active ester groups can be performed in the presence of 1-amino-2-propanol at room temperature, from 0.5 to 1 hours. The conjugate suitably is precipitated with ethyl acetate, dissolved with ethanol and precipitated with ethyl acetate.

For example the preparation of a water soluble enzyme-activated conjugate of 7-ethyl-10-hydroxy-camptothecin with polymer W1 in which R₄ of formula (28) represents the residue of an active ester such as p-nitrophenol, provided at a concentration of 15% (w/v) in dry dimethylsulfoxide, is treated with compound of formula (18a), 3% (w/v), in presence of a tertiary amine such as DIPEA or triethylamine, at room temperature for 15 hours. Then 1-amino-2-propanol in DMF, 0.1% (w/v) is added and the reaction mixture is kept at room temperature for 8 hours. The resulting polymer drug-conjugates (2a) can be precipitated with ethyl acetate, collected, washed with ethyl acetate, then dissolved with absolute ethanol at a concentration of 10% (w/v), treated with a sulfonic resin, filtered and precipitated again with ethyl acetate.

The process is illustrated in Scheme 3.

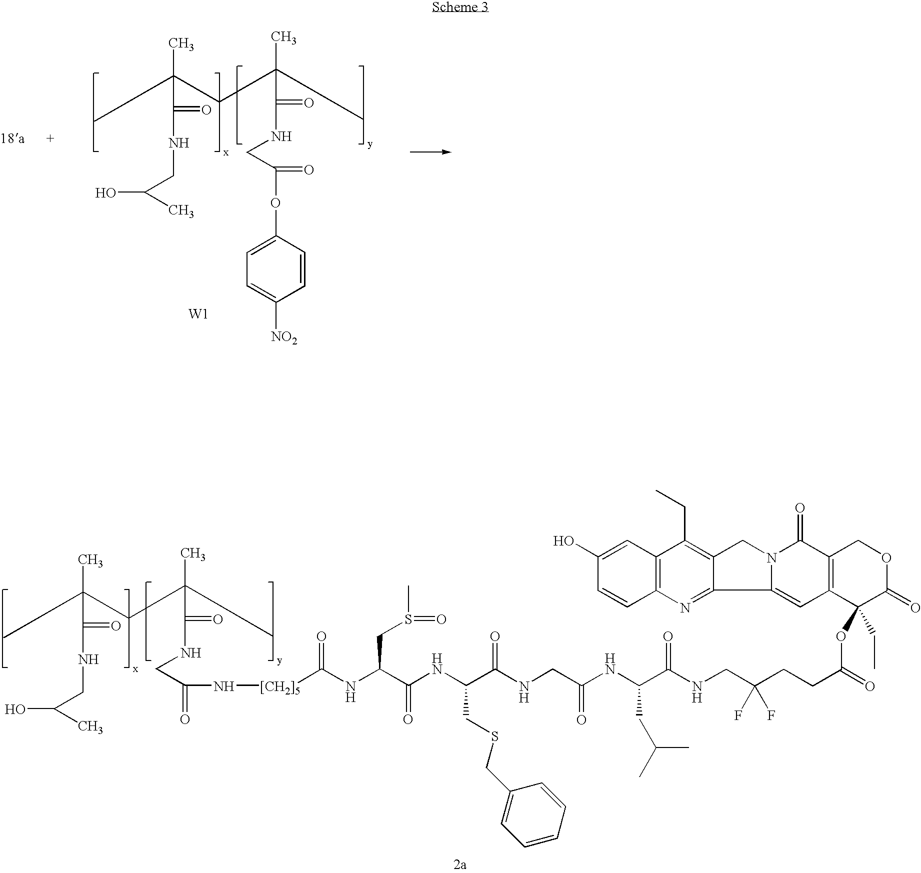

The content of active drug in polymeric conjugate of the invention is determined by HPLC or absorbency spectroscopy analysis. The water soluble polymer of enzyme-activated drug conjugates of formula (2) are in the range of 5.000 to 45.000 molecular weight, preferably from 10.000 to 25.000. Compounds of formula (2) and other compounds of the invention are water-soluble and show enhanced antitumor activity and reduced toxicity in comparison with the free drug. They are useful in the treatment of leukemia and solid tumors, such as colon, colo-rectal, ovarian, mammary, prostate, lung, kidney and also melanoma tumors. A human can therefore be treated by a method comprising administering thereto a therapeutically effective amount of a polymeric conjugate of the invention. The condition of the human patient can thus be improved.

The dosage range adopted will depend on the route of administration and on the age, weight and condition of the patient being treated. The polymeric drug-conjugates of formula (xx) is typically administered by parenteral route, for example intramuscularly, intravenously or by bolus infusion. A suitable dose range is from 1 to 1000 mg of equivalent per m² body surface area of active drug, for instance from 10 to 500 mg/m².

The water soluble polymer of enzyme-activated drug conjugates (2) may be formulated into a pharmaceutical composition together with a pharmaceutically carrier or diluent. Typically they are formulated for parenteral administration, for example by dissolution in water for injection or physiological saline.

Enzyme Assay

The degradation of water soluble polymer of enzyme-activated drug conjugates of formula (2) in vitro was investigated in buffer and in the presence of several proteolytic enzymes (matrix metalloproteinases, MMP's, serine proteases (elastase) and in plasma.

Compounds (2) were dissolved in sterile distilled water at the standard concentration of 10 mM. Concentrations were calculated as equivalent of drug according to the polymer loading percentage (5-10 wt % drug). Compounds (2) were assayed in 50 mM Tris/HCl pH 7.4 buffer containing 0.15 M NaCl, 10 μM CaCl₂, 0.01 mM Zn acetate and 0.05% C₁₂ E₉. Compounds (2) were equilibrated at 37° C. in buffer for 5 minutes at the concentrations varying from 5 to 1000 μM. Reactions started by addition of enzymes (MMPs) to a final concentration of 50 SM. Enzymatic reactions were stopped within 5% of hydrolysis of polymeric drug-conjugates by adding 0.05% TFA buffer (pH 2.5) and subsequently analyzed by RP-HPLC through a, aquapore OD300 column.

The quantification of products of reaction was obtained by RP-HPLC. For example with a Perkin Elmer HPLC consisting of an ISS 200 autosampler, a Series 200LC pump, and a LC240 fluorescence detector, or, alternatively, a Waters HPLC consisting of 717-plus autosampler, a Model 600 pump and a Model 474 fluorimeter. We found that the compound of the formula (2) of present invention selectively releases the antitumor agent D in presence of gelatinase, are substantially stable in plasma and in presence of other proteolytic enzymes and show antitumor efficacy higher than that of the corresponding free drug.

The following examples illustrate the invention without limiting it.

### EXAMPLE 1

### N-phtaloyl-5-amino-4-oxo-pentanoic Acid (6′)

5-aminolevulinic acid hydrochloride (5′; 9.4 g, 56 mmol) was dissolved in water (65 ml) and added with N-ethoxycarbonylphtalimid (12.3 g, 56 mmol) and sodium carbonate (8.9 g, 84 mmol). The reaction mixture was kept under stirring for 4 h at room temperature and then filtered off; the white solid was washed with water and discarded. The aqueous layer was brought to pH 1-2 with 4N aqueous hydrogen chloride so that precipitation of product occurs. The solid containing the title compound was filtered, washed with little water and dried to give compound (6′; 6.7 g). Yield 46%. TLC on kieselgel plate (Merck), eluting system methylene dichloride/methanol (9:1 v/v) Rf=0.45.

¹HNMR (400 MHz, DMSO) δ: 7.9-7.85 (m, 4H); 4.58 (s, 2H); 2.81 (t, J=6.7 Hz, 2H).

### EXAMPLE 2

### Ethyl N-phtaloyl-5-amino-4-oxo-pentanoate (7′)

N-phtaloyl-5-amino-4-oxo-pentanoic acid (6′; 6.8 g, 26 nmol), prepared as described in Example 1, was dissolved in toluene (200 ml), absolute ethanol (20 ml), added with p-toluensulfonic acid monohydrate (1 g, 5.2 mmol) and refluxed for 2 h in a round-necked flask equipped with a Dean-Stark apparatus. The solvent was evaporated under reduced pressure and the residue was diluted with ethyl acetate.

The organic layer was washed with aqueous sodium bicarbonate (3×100 ml) and once with brine. After drying with sodium sulphate, filtration and solvent evaporation, the title compound (7′, 7.5 g) was isolated in quantitative yield. TLC on kieselgel plate (Merck), eluting system methylene dichloride/methanol (95:5 v/v) Rf=0.85.

### EXAMPLE 3

### Benzyl N-phthaloyl-4-amino-3-oxo-butyrrate (10)

Phthaloyl glycine (8; 20.5 g; 100 mmole) and Meldrum's acid (17.28 g; 120 mmole) were dissolved in dimethylformamide (200 ml), added with 1,1′-carbonyldiimidazole (19.44 g; 120 mmole) and kept at room temperature under stirring for 24 hours. After that the solvent was removed under reduced pressure; the residue was taken with ethyl ether (500 ml), and collected on a sintered glass funnel. The solid was washed with the same solvent (3×200 ml) to give intermediate (9; 44 g).

FD-MS: m/z 330.

¹HNMR (400 MHz, DMSO) δ: 8.87 (b, 1H); 7.87-7.47 (m, 4H); 4.59 (s, 2H); 1.49 (s, 6H).

Compound (9) was dissolved in acetonitrile (400 ml), treated with benzyl alcohol (56 ml) at reflux for 18 hours. After cooling at room temperature n-hexane (1 L). was added. The precipitate obtained was first dissolved with methylene dichloride (200 ml), then adsorbed on silica gel (50 g) in presence of n-hexane (200 ml). The silicagel absorbed compound, after evaporation of solvents, was flash chromatographed on silica gel. The eluting system was in sequence: a mixture of n-hexane and ethyl ether (1:1 v/v) to remove the by-products, then a mixture of methylene dichloride and acetone (95:5 v/v) to collect the title compound (10; 21 g). This was crystallized from n-hexane. TLC on kieselgel plate (Merck), eluting system diethyl ether/n-hexane (2:1 v/v) Rf==0.4.

FD-MS: m/z 336.

¹HNMR (400 MHz, DMSO) δ: 7.92-7.86 (m, 4H); 7.37-7.32 (m, 5H); 5.14 (s, 2H); 4.70 (s, 2H); 3.92 (s, 2H).

### EXAMPLE 4

### Ethyl N-phthaloyl-5-amino-4-oxo-pentanoate (7′)

Sodium hydride 80% in paraffin (2.2 g; 74 mmole) was suspended in dry tetrahydrofurane (150 ml), cooled at 0° C., and a solution of compound (10; 21 g; 62 mmole) in dry tetrahydrofurane (250 ml) was added dropwise. After 1 h the reaction mixture was added with a solution of ethyl bromoacetate (8.2 ml; 80 mmole) in dry tetrahydrofurane (75 ml). The reaction mixture was left under stirring at 0° C. for 2 hours, then was added with dry dimethylformamide (100 ml) and kept at room temperature for 24 hours. After that the reaction mixture was cooled at 4° C. and treated with 1N aqueous hydrochloric acid (450 ml) and extracted with ethyl acetate (1 L). The organic phase was dried over anhydrous sodium sulphate and the solvent was removed under reduced pressure. The residue was dissolved with methanol (150 ml) under stirring, added with Pd/C 10% (5 g), cooled at 4° C. and added with cyclohexadiene (90 ml). The reaction mixture was brought to 50° C. for 15 hours, then cooled at room temperature and filtered. The solvent was removed under reduced pressure and the residue was flash chromatographed on silica gel using as eluting system a mixture of n-hexane/diethyl ether, first 1:1 v/v and then a mixture of methylene chloride and methanol 1:2 v/v to give the title compound (7′; 9.4 g). TLC on kieselgel plate (Merck), eluting system diethyl ether/n-hexane(15:10 v/v) Rf=0.21.

FD-MS: m/z 307.

¹HNMR (400 MHz, DMSO) δ: 7.91-7.85 (m, 4H); 4.59 (s, 2H); 4.01 (q, J=7 Hz); 2.86 (t, J=6.44 Hz, 2H); 1.15 (t, J=7.09 Hz, 3H).

### EXAMPLE 5

### Ethyl N-phthaloyl-5-amino-4,4′-difluoro-pentanoate (1′a)

Compound (7′; 6.7 g; 23 mmole), prepared as described in Example 2 or 4, was dissolved in methylene dichloride (20 ml), cooled at 4° C. and treated with diethylaminosulfur trifluoride, DAST (17 ml; 123 mmole). The reaction mixture was left at room temperature for three days, then poured into water and ice and extracted with methylene chloride (500 ml). The organic phase was washed with water, dried over anhydrous sodium sulphate and the solvent removed under reduced pressure. The residue was flash chromatographed on silica gel using as eluting system methylene dichloride and acetone. The recovered compound (1′a; 3.4 g) was crystallized from diethyl ether/n-hexane (1:1 v/v). TLC on kieselgel plate (Merck), eluting system diethyl ether/n-hexane (2:1 v/v) Rf=0.38.

FD-MS: m/z 312.

¹HNMR (400 MHz, DMSO) δ: 7.93-7.85 (m, 4H); 4.08-4.00 (m, 4H); 2.52-2.26 (m, 2H); 1.17 (t, J=7.09 Hz, 3H).

### EXAMPLE 6

### t-Butoxycarbonyl-5-amino-4,4′-difluoro-pentanoic Acid (1′c)

Compound (1a; 4.4 g; 14 mmole), prepared as described in Example 5, was treated at reflux for 8 hours with 6N aqueous hydrochloric acid (200 ml). Then the solvent was removed under reduced pressure and the residue, containing compound (1′b) cooled at 4° C., was dissolved with a 10% solution of triethylamine in methanol and added with di-tert-butyl dicarbonate (12.3 g; 56 mmole). After 2 hours the solvent was removed under reduced pressure and the residue suspended with 1N aqueous hydrochloric acid (150 ml) and extracted with ethyl acetate (500 ml). The organic phase was separated, washed with water, dried over anhydrous sodium sulphate and the solvent was removed under reduced pressure. The oily residue was flash chromatographed on silica gel using as eluting system a mixture of methylene chloride and methanol (97:3 v/v) to give the title compound (1′c; 2.6 g). TLC on kieselgel plate (Merck), eluting system methylene chloride/methanol (9:1 v/v) Rf=0.41.

FD-MS: m/z 252.

¹HNMR (400 MHz, DMSO) δ: 7.27 (b, 1H); 3.45-3.20 (m, 2H); 2.37 (t, J=3.5 Hz, H); 2.06 (m, 2H).

### EXAMPLE 7

### 4-nitrophenyl, t-butoxycarbonyl-5-amino-4,41-difluoro-pentanoato (1′d)

A mixture of compound (1′c; 2.5 g, 10 mmole), prepared as described in Example 6, and p-nitrophenol (1.6 g; 12 mmole) was dissolved in tetrahydrofurane (40 ml), cooled at 0° C. and added dropwise with a solution of dicyclohexylcarbodiimide (2.4 g; 12 mmole) in tetrahydrofurane (20 ml). The reaction mixture was kept under stirring at 0° C. for 4 hours, then at room temperature for 4 hours and at 4° C. overnight. After that the reaction mixture was filtered and the solution evaporated to dryness. The residue was kept with ethyl acetate (100 ml), cooled at 4° C. for 2 hours and filtered again. The solvent was removed under reduced pressure and the residue was flash chromatographed on silica gel eluting with methylene dichloride to give the title compound (1′d; 3.6 g). TLC on kieselgel plate (Merck), eluting system methylene dichloride/acetone (9:1 v/v) R_{f}=0.56.

### EXAMPLE 8

### 7-ethyl-10-hydroxy-20-O-[5′-amino-4′,4′-difluoropentanoyl]-camptothecin Hydrochloride (12′a).

7-Ethyl-10-hydroxycamptothecin (4; 1.68 g; 4 mmol) was dissolved in anhydrous dimethylsulfoxide (20 ml) and added with 5-N-t-butoxycarbonyl-5-amino-4,4′-difluoro pentanoic acid p-nitrophenyl ester (1′d; 3.6 g; 10 mmol), prepared as described in Example 7, and dimethylaminopyridine (1.4 g; 12 mmol). The reaction mixture was kept in argon atmosphere under stirring for 24 h at room temperature Afterwards morpholine (1.9 g; 20 mmole) was added and the reaction mixture was kept under stirring for 2 h at room temperature. Then methylene dichloride (400 ml) and 0.5N aqueous hydrochloric acid (100 ml) were added. The organic phase was separated and washed with water (2×200 ml), the organic solvent was removed under reduced pressure and the residue was flash chromatographed on silica gel using as eluting system a mixture of methylene dichloride and acetone (9:1 v/v) to give 7-ethyl-10-hydroxy-20-O-[5′-N-t-butoxycarbonyl-amino-4,4′-difluoropentanoyl]-camptothecin (11a; 1.8 g). TLC on kieselgel plate (Merck), eluting system methylene dichloride/acetone (9:1 v/v) Rf=0.21.

FD-MS: m/z 628.

¹HNMR (400 MHz, DMSO) δ: 8.01 (d, J=9.84 Hz, 1H); 5.45 (s, 2H); 3.42-3.0 (m, 2H); 1.32 (s, 9H)

Compound (11a; 1.8 g) was dissolved in a solution 1N hydrochloric acid in acetic acid (30 ml) and left at room temperature for 2 hours. The reaction mixture was concentrated to small volume and the title compound (12′a; 1.6 g) was precipitated from ethyl ether. TLC on kieselgel plate (Merck), eluting system methylene dichloride/methanol (9:1 v/v) Rf=0.39.

FD-MS: m/z 528.

¹HNMR (400 MHz, DMSO) δ: 7.02 (s, 1H); 5.48 (s, 2H); 3.5-3.38 (m, 2H); 2.88-2.70 (m, 2H).

### EXAMPLE 9

### 7-ethyl-10-hydroxy-20-O-[leucyl-(5-amino-4,4′-difluoropentanoyl)]-camptothecin Hydrochloride (22′a)

Compound (12′a; 1.6 g, 2.8 mmol), prepared as described in Example 8, N-t-butoxycarbonyl-leucine (1.4 g; 5.6 mmol), 1-hydroxybenzotriazole (HOBt) (0.83 g, 5.6 mmol), O-(benzotriazol-lyl)-N,N,N′,N′-tetramethyluronium tetrafluoborate (TBTU) (1.8 g, 5.6 mmol) were dissolved in DMF (30 ml) and diisopropyl ethylamine (DIPEA) (2.9 ml, 16.8 mmol) was added. The reaction mixture was kept under stirring overnight at room temperature. Then morpholine (2.4 ml, 20 mmol) was added and the mixture was stirred for six hours. After that the solvent was evaporated under reduced pressure, the residue was dissolved with methylene chloride (200 ml) and washed with aqueous 0.5N HCl (200 ml) and water (2×100 ml). The organic phase was dried over anhydrous sodium sulphate, then the solvent was removed under reduced pressure. The residue was flash chromatographed on silica gel using as eluting system a mixture of methylene dichloride and acetone (8:2 v/v) to give 7-ethyl-10-hydroxy-20-O-[N-t-butoxycarbonyl-leucyl-(5′-amino-4,4′-difluoropentanoyl)]-camptothecin (21a; 2 g). TLC on kieselgel plate (Merck), eluting system methylene dichloride/methanol (97:3 v/v) Rf=0.18. Compound (21a; 2 g) was dissolved in 1N hydrochloric acid in acetic acid (30 ml) and left at room temperature for 2 hours. After that the reaction mixture was concentrated to small volume and the title compound (22′a; 1.7 g) was collected after precipitation with diethyl ether. TLC on kieselgel plate (Merck), eluting system methylene dichloride/methanol (8:2 v/v) Rf=0.56.

FD-MS: m/z 641.

¹HNMR (400 MHz, DMSO) δ: 8.01 (d, J=9.84 Hz, 1H); 5.47 (s, 2H); 5.28 (d, J=2.29 Hz, 2H); 0.92 (t, J=7.32 Hz, 6H).

### EXAMPLE 10

### 7-Ethyl-10-hydroxy-20-O-[(6-aminohexanoyl)-methionylsulfoxide-glycyl-(S-benzyl-cysteinyl)-leucyl-(5′-amino-4,4′-difluoropentanoyl)]-camptothecin Trifluoroacetate (18′a)

Compound (22′a; 0.75 g; 1.1 mmol), prepared as described in Example 9, N-t-butoxycarbonyl-(6-amino hexanoyl-methionylsulfoxide-glycyl-(S-benzyl-cysteine) (1.4 g, 2.2 mmol), 1-hydroxy-benzo-triazole (HOBt) (0.33 g, 2.2 mmol), O-(benzotriazol-lyl)-N,N,N′,N′-tetramethyl uronium tetrafluoborate (TBTU) (0.7 g, 2.2 mmol) were dissolved in DMF (20 ml) and diisopropyl ethylamine (DIPEA) (2.2 ml, 13 mmol) was added. The reaction mixture was kept under stirring overnight at room temperature. Then dry piperazine (0.43 g, 5 mmol) was added and the mixture was stirred at room temperature for 1 hour. After that the reaction mixture was diluted with ethyl acetate (200 ml), washed with 0.5N aqueous hydrochloric acid (100 ml), cold water (2×100 ml). The organic phase was dried over anhydrous sodium sulphate and the solvent was removed under reduced pressure. The residue was flash chromatographed on silica gel using as eluting system a mixture of methylene dichloride and methanol (97:3 v/v) to give 7-Ethyl-10-hydroxy-20-O-(N-t-butoxycarbonyl-(6-aminohexanoyl)-methionylsulfoxide-glycyl-(S-benzyl-cysteinyl)-leucyl-(5′-amino-4,4′-difluoropentanoyl)]-camptothecin (16a; 1 g). TLC on kieselgel plate (Merck), eluting system methylene dichloride and methanol (9:1 v/v) R_{f}=0.27. Compound (16a; 1 g) was dissolved in a mixture of trifluoroacetic acid water (95:5 v/v; 20 ml) and left under stirring for 1 hour. After that methanol (5 ml) was added and the title compound (18′a; 1 g) was collected after precipitation with diethyl ether. TLC on kieselgel plate (Merck), eluting system methylene dichloride/methanol/acetic acid/water (80:20:7:3 v/v) Rf=0.35.

FD-MS: m/z 1151.

¹HNMR (400 MHz, DMSO) δ: 8.01 (d, J=7.7 Hz, 1H); 4.6-4.2 (m, 3H); 3.74 (q, J=8 Hz, 2H).

### EXAMPLE 11

### Copolymer of: N-(2-hydroxypropyl)methacryloylamide and 7-Ethyl-10-hydroxy-20-O-[methacryloyl-glycyl-6-aminohexanoyl-(methionyl-sulfoxide)-glycyl-(S-benzyl-cysteinyl)-leucyl-(5-amino-4,4′-difluoropentanoyl)]-camptothecin and N-(2-hydroxypropyl)methacryloylglycinamide (2a)

To a solution in anhydrous dimethylsulfoxide (16 ml) of polymer (W1; 3.17 g; 1.62 meq of p-nitrophenyl), were added compound (18′a; 1 g; 0.81 mmol), prepared as described in Example 10, and triethylamine (0.225 ml, 1.62 mmol). The reaction mixture was kept in argon atmosphere under stirring at room temperature for 24 h. Then a 3% solution of 1-amino-2-propanol in dimethylformamide (4.23 ml) was added and stirring was continued for 8 h. After that ethyl acetate (600 ml) was added to the reaction mixture under stirring. The precipitate was collected, washed with ethyl acetate (3×30 ml) and dissolved with ethanol (30 ml) and treated with DOWEX 50-sulfonic acid for 30 min. The solution was filtered and precipitated with ethyl acetate. The resultant solid was washed with diethyl ether and dried at constant weight to give the title compound (2a; 3.73 g). Mw 20.800, polydispersity 1.48, loading of 7-ethyl-10-hydroxy-camptothecin 6.6% (w/w %).

1. A compound of formula (1)
R₁—HN—CH₂—CF₂—(CH₂)ₗ—CR₃R₄—CO—R₂ (1)
wherein:
l is 0, 1 or 2;
R₁ is a labile amino protecting group; R₂ is hydroxy, the residue of an activated ester or a halogen atom; and R₃ and R₄ which are the same or different, are independently hydrogen or C₁-C₄ alkyl.

2. A compound according to claim 1 wherein l is 1, R₃ and R₄ are hydrogen atoms, R₁ is selected from tert-butoxycarbonyl, 9-fluorenyl methoxycarbonyl, triphenylsilyl, diphenylmethylene and triphenylmethyl group, and R₂ is p-nitrophenol or N hydroxysuccinimido residue or chlorine atom.

3. A compound of formula (2:
W—[—HN—Y—CO—]ₚ—S₀—HN—CH₂—CF₂—(CH₂)ₗ—CR₃R₄—CO-D (2)
wherein:
D is the residue of a drug bearing secondary or tertiary hydroxyl groups linked through an ester bond;
R₃ and R₄, which are the same or different, are independently hydrogen or C₁-C₄ alkyl
l is 0, 1 or 2;
S₀ is a peptide capable of being selectively cleaved at a tumor site by enzymes there expressed in an active form;
Y is C₂-C₁₂ linear or branched alkylene chain which is unsubstituted or substituted by hydroxyl, p is 0 or 1, and
W is a water-soluble polymer or a water-soluble low molecular weight compound.

4. A compound according to claim 3 wherein Y represents —(CH₂)₅—,
p is 1 and
W represents a polypyrrolecarboxamidonaphthalene derivative, polyglutamic acid, acarboxylated dextrane, carboxylated polyethylenglycol or a polymer based on hydroxypropylmethacryloylamide.

5. A compound according to claim 3 wherein W is a water soluble polymer based on N-(2-hydroxypropyl) methacryloylamide.

6. A compound according to claim 3 in which the peptide S₀ comprises sequences from four to five natural or synthetic amino acids.

7. A compound according to claim 3 wherein S₀ represents a sequence of formula:
Met(O)-Gly-Cys(Bn)-Leu, Met(O)-Gly-Cys(Bn)-Gly, Met(O)-Gly-Cys (Bn)-Gly-Leu, Met(O)-Gly-Cys(Bn)-Trp-Gly, Met(O)-Gly-Cys(Bn) pFF-Gly, Met (O)-Gly-Cys(Bn)-Gly-Gly, Met(O)-Gly-Cys(Bn)-Leu-Gly, Smc-Gly-Cys(Bn)-Leu, Smc-Gly-Cys(Bn)-Trp, Smc-Gly-Cys(Bn)-pFF, Smc-Gly-Cys(Bn)-Gly, Smc-Gly-Cys(Bn)-Trp-Gly, Smc-Gly-Cys(Bn)-pFF Gly, Smc-Gly-Cys(Bn)-Gly-Gly, Smc-Gly-Cys(Bn)-Leu-Gly, Smc-Gly Leu-Trp, Smc-Gly-Tha-Trp, Smc-Gly-Met-Trp, Smc-Gly-Tha-Trp-Gly, Smc-Gly-Met-Trp-Gly, Leu-Gly-Cys(Bn)-Leu, Leu-Gly-Cys(Bn)-Gly, Leu-Gly-Cys(Bn)-Leu-Gly, Leu-Gly-Cys(Bn)-Gly-Gly, Leu-Gly-Leu-Leu, Leu-Gly-Leu-Trp, Leu-Gly-Leu-Leu-Gly or Leu-Gly-Leu-Trp-Gly.

8. A compound according to claim 3 wherein S₀ represents a sequence of formula: Met(O)-Gly-Cys(Bn)-Leu, Met(O)-Gly-Cys (Bn)-Gly, Met(O)-Gly-Cys(Bn)-Gly-Gly, Met(O)-Gly-Cys(Bn) Leu-Gly, Smc-Gly-Cys(Bn)-Leu, Smc-Gly-Cys(Bn)-Gly, Smc-Gly Cys(Bn)-Gly-Gly, Smc-Gly-Cys(Bn)-Leu-Gly, Leu-Gly-Cys(Bn)-Leu, Leu-Gly-Cys(Bn)-Gly, Leu-Gly-Cys(Bn)-Leu-Gly, Leu-Gly-Cys(Bn)-Gly Gly, Leu-Gly-Leu-Leu or Leu-Gly-Leu-Leu-Gly.

9. A compound according any claim 3 wherein the antitumor agent D is a cytotoxic agent belonging to the class of camptothecins, anthracyclines, taxanes, vinca alkaloids, cytotoxic nucleosides or podophyllotoxins.

10. A compound according to claim 9 wherein the antitumor agent D is camptothecin, 7-ethyl-10-hydroxy-camptothecin, 9-aminocamptothecin, doxorubicin, daunorubicin, 4′-epidoxorubicin, 4-demethoxydaunorubicin, 3′-(2-methoxymorpholino) doxorubicin, 4-deacetylvinblastine, 4-deacetyl-vincristine, vindesine, paclitaxel, docetaxel or, etoposide.

11. A process for preparing a compound of formula (1) as defined in claim 1, which process comprises reacting a compound of formula II
R′₁—HN—CH₂—CH₂—(CH₂)ₗ—CR₃R₄—COOR′₂ II
wherein R₃ and R₄ are the same or different, and are independently hydrogen or C₁-C₄ alkyl, l is 0, 1 or 2, R′₁ is an N protecting group and R′₂ is C₁-C₄ alkyl, phenyl or phenyl-C₁-C₄ alkyl, with a fluorinating agent, then removing the N-protecting group and the ester residue from the resultant compound of formula III
R′₁—HN—CH₂—CF₂—(CH₂)ₗ—CR₃R₄—COOR′₂ III
wherein R₃ and R₄ and l are as defined in claim 1, R′₁ is an N protecting group and R′₂ is C₁-C₄ alkyl, phenyl or phenyl-C₁-C₄ alkyl; and then introducing a labile N-protecting group R₁, and optionally the activating ester residue R₂ is hydroxy the residue of an activated ester or a halogen atom, into the resultant amino acid derivative of formula IV
H₂N—CH₂—CF₂—(CH₂)ₗ—CR₃R₄—COOH IV
wherein R₃ and R₄ are the same or different, and are independently hydrogen or C₁-C₄ alkyl and l is 0, 1 or 2, to give a desired compound of the formula (1).

12. A process according to claim 11 in which the N-protecting group R′₁ is a phthaloyl protecting group and the fluorinating agent is DAST.

13. A process for preparing a compound of formula (2) as defined in claim 3, which process comprises reacting a compound of formula (18)
H—[—HN—Y—CO—]ₚ—S₀—HN—CH₂—CF₂—(CH₂)ₗ—CR₃R₄—CO-D (18)
wherein Y, p, S₀, l, R₃, R₄ and D are as defined in claim 3, with a polymer or water soluble molecule W bearing suitable functional groups for the coupling with a compound (18).

14. A process according to claim 13 in which the suitable functional groups on polymer W for the attachment to compounds (18) comprise carboxyl groups or activated carboxyl groups.

15. An antitumor derivative of formula (18) as claimed in claim 13 or a corresponding salt derivative of formula (18′).

16. A process for preparing a compound of formula (18) or salt (18′) as defined in claim 15, which process comprises:
removing under acidic conditions the N-protecting group from a derivative of formula (16);
R₁—[—HN—Y—CO—]ₚ—S₀—HN—CH₂—CF₂—(CH₂)ₗ—CR₃R₄—CO-D (16)
wherein R₁, Y, p, S₀, l, R₃, R₄ and D are as defined in claim 3, and
optionally converting a resultant compound of general formula (18′) into the corresponding free amino derivative (18) by mild basic treatment.

17. A process according to claim 16 in which the N-protecting group R₁ represents tert-butoxycarbonyl, 9-fluorenyl methoxycarbonyl, triphenylsilyl, diphenylmethylene or triphenylmethyl group.

18. A compound according to claim 3 which is a drug conjugate consisting of:
(i) from 85 to 97 mol % of N-(2-hydroxypropyl) methacryloylamide units represented by formula (26) 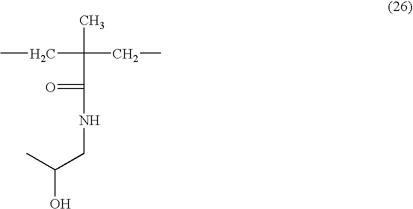
(ii) from 3 to 15 mol % of units represented by formula (27) 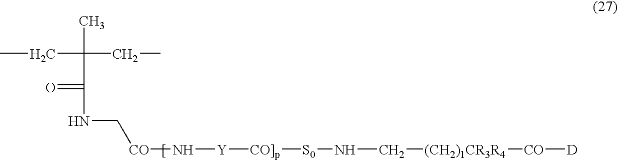
in which Y, p, l, S₀, R₃, R₄ and D and are as defined in claim 3, and
(iii) from 0 to 12 mol % of N-methacryloyl-glycine or N-(2-hydroxypropyl) methacryloyl glycinamide units represented by formula (28) 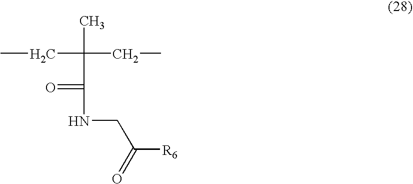
wherein R₆ represents a hydroxy group or a residue of formula —NH—CH₂—CH(OH)—CH₃.

19. A process for preparing a drug-conjugate as defined in claim 18, which process comprises reacting a compound of formula (18) or a salt thereof with an activated water soluble polymer (W′) consisting essentially of: activated polymer W′ consisting essentially of: (i) from 85 to 97 mol % of N-(2-hydroxypropyl) methacryloylamide units represented by formula (26) as defined in claim 18, and (ii) from 3 to 15 mol % of N-methacryloyl-glycyl units represented by formula (29) 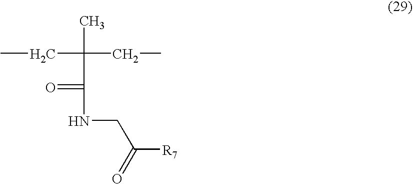
wherein R₇ is the residue of an active ester, and optionally displacing the remaining active ester groups with 1-amino-2-propanol.

20. A pharmaceutical composition comprising a pharmaceutically acceptable diluent or carrier and, as active ingredient, a polymeric conjugate as defined in claim 3.

21. (canceled)

22. (canceled)

23. (canceled)

24. A pharmaceutical composition comprising a pharmaceutically acceptable diluent or carrier and, as active ingredient, a compound of formula (18) or (18′) as defined in claim 15.

25. A method of treating for leukemia or a solid tumor in a human or an animal comprising administering the polymeric conjugate of claim 3 to the human or an animal wherein the leukemia or solid tumor is treated.

26. The method of claim 25, wherein the solid tumor is a colon, colo-rectal, ovarian, mammary, prostate, lung or kidney tumor or a melanoma.

27. A method of treating for leukemia or a solid tumor in a human or an animal comprising administering the compound of formula (18) or (18′) as defined in claim 15 to the human or an animal, wherein the leukemia or solid tumor is treated.

28. The method of claim 27, wherein the solid tumor is a colon, colo-rectal, ovarian, mammary, prostate, lung or kidney tumor or a melanoma.


SEQUENCE LISTING (28 sequences)

SEQ ID NO: 1 - protein, 4 aa, Artificial Sequence
  Description of Artificial Sequence Synthetic
XGXL

SEQ ID NO: 2 - protein, 4 aa, Artificial Sequence
  Description of Artificial Sequence Synthetic
XGXG

SEQ ID NO: 3 - protein, 5 aa, Artificial Sequence
  Description of Artificial Sequence Synthetic
XGXGL

SEQ ID NO: 4 - protein, 5 aa, Artificial Sequence
  Description of Artificial Sequence Synthetic
XGXWG

SEQ ID NO: 5 - protein, 5 aa, Artificial Sequence
  Description of Artificial Sequence Synthetic
XGXXG

SEQ ID NO: 6 - protein, 5 aa, Artificial Sequence
  Description of Artificial Sequence Synthetic
XGXGG

SEQ ID NO: 7 - protein, 5 aa, Artificial Sequence
  Description of Artificial Sequence Synthetic
XGXLG

SEQ ID NO: 8 - protein, 4 aa, Artificial Sequence
  Description of Artificial Sequence Synthetic
XGXL

SEQ ID NO: 9 - protein, 4 aa, Artificial Sequence
  Description of Artificial Sequence Synthetic
XGXW

SEQ ID NO: 10 - protein, 4 aa, Artificial Sequence
  Description of Artificial Sequence Synthetic
XGXX

SEQ ID NO: 11 - protein, 4 aa, Artificial Sequence
  Description of Artificial Sequence Synthetic
XGXG

SEQ ID NO: 12 - protein, 5 aa, Artificial Sequence
  Description of Artificial Sequence Synthetic
XGXWG

SEQ ID NO: 13 - protein, 5 aa, Artificial Sequence
  Description of Artificial Sequence Synthetic
XGXXG

SEQ ID NO: 14 - protein, 5 aa, Artificial Sequence
  Description of Artificial Sequence Synthetic
XGXGG

SEQ ID NO: 15 - protein, 5 aa, Artificial Sequence
  Description of Artificial Sequence Synthetic
XGXLG

SEQ ID NO: 16 - protein, 4 aa, Artificial Sequence
  Description of Artificial Sequence Synthetic
XGLW

SEQ ID NO: 17 - protein, 4 aa, Artificial Sequence
  Description of Artificial Sequence Synthetic
XGXW

SEQ ID NO: 18 - protein, 4 aa, Artificial Sequence
  Description of Artificial Sequence Synthetic
XGMW

SEQ ID NO: 19 - protein, 5 aa, Artificial Sequence
  Description of Artificial Sequence Synthetic
XGXWG

SEQ ID NO: 20 - protein, 5 aa, Artificial Sequence
  Description of Artificial Sequence Synthetic
XGMWG

SEQ ID NO: 21 - protein, 4 aa, Artificial Sequence
  Description of Artificial Sequence Synthetic
LGXL

SEQ ID NO: 22 - protein, 4 aa, Artificial Sequence
  Description of Artificial Sequence Synthetic
LGXG

SEQ ID NO: 23 - protein, 5 aa, Artificial Sequence
  Description of Artificial Sequence Synthetic
LGXLG

SEQ ID NO: 24 - protein, 5 aa, Artificial Sequence
  Description of Artificial Sequence Synthetic
LGXGG

SEQ ID NO: 25 - protein, 4 aa, Artificial Sequence
  Description of Artificial Sequence Synthetic
LGLL

SEQ ID NO: 26 - protein, 4 aa, Artificial Sequence
  Description of Artificial Sequence Synthetic
LGLW

SEQ ID NO: 27 - protein, 5 aa, Artificial Sequence
  Description of Artificial Sequence Synthetic
LGLLG

SEQ ID NO: 28 - protein, 5 aa, Artificial Sequence
  Description of Artificial Sequence Synthetic
LGLWG